(19) United States
(12) Patent Application Publication
(10) Pub. No.: US 2011/0263775 A1
(43) Pub. Date: Oct. 27, 2011

(54) PHOSPHINE OXIDE CONTAINING PHTHALONITRILES

(75) Inventors: Matthew Laskowski, Springfield, VA (US); Teddy M. Keller, Fairfax Station, VA (US)

(73) Assignee: The Government of the United States of America, as represented by the Secretary of the Navy, Washington, DC (US)

(21) Appl. No.: 13/176,009

(22) Filed: Jul. 5, 2011

Related U.S. Application Data
(63) Continuation of application No. 11/851,411, filed on Sep. 7, 2007, now abandoned.
(60) Provisional application No. 60/911,524, filed on Apr. 13, 2007.

(51) Int. Cl. C08K 3/22; C08L 85/02; C08G 79/04; C08K 3/34; B82Y 30/00

(52) U.S. Cl. 524/432; 528/168; 524/445; 524/430; 524/610; 525/534; 977/742

(57) ABSTRACT

Compounds having the formulas below. Each R¹ is an aromatic-containing group. Each R² is methyl or phenyl. M is an alkali metal, and n is a positive integer. A thermoset made by curing a mixture comprising a curing agent and the below phthalonitrile monomer. A method of: reacting bis(4-fluorophenyl)phenylphosphine oxide, bis(4-fluorophenyl)methylphosphine oxide, or a mixture thereof with an excess of an aromatic diol in the presence of an alkali metal carbonate to form the oligomer below.

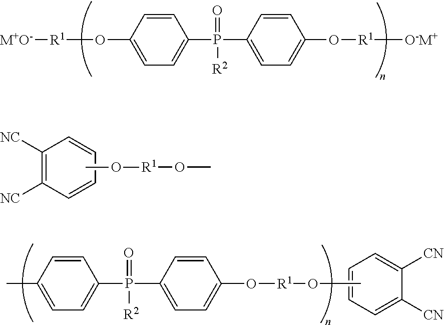

This application is a continuation application of U.S. patent application Ser. No. 11/851,411, filed on Sep. 7, 2007, which claims the benefit if U.S. Provisional Application No. 60/911,524 filed on Apr. 13, 2007. This application and all other referenced patent documents and publications throughout this application are incorporated herein by reference.

### FIELD OF THE INVENTION

The invention is generally related to phthalonitriles.

### DESCRIPTION OF RELATED ART

Phthalonitrile monomers and phthalonitrile polymers of various types are described generally in U.S. Pat. No. 3,730,946, U.S. Pat. No. 3,763,210, U.S. Pat. No. 3,787,475, U.S. Pat. No. 3,869,499, U.S. Pat. No. 3,972,902, U.S. Pat. No. 4,209,458, U.S. Pat. No. 4,223,123, U.S. Pat. No. 4,226,801, U.S. Pat. No. 4,234,712, U.S. Pat. No. 4,238,601, U.S. Pat. No. 4,259,471, U.S. Pat. No. 4,304,896, U.S. Pat. No. 4,307,035, U.S. Pat. No. 4,315,093, U.S. Pat. No. 4,351,776, U.S. Pat. No. 4,408,035, U.S. Pat. No. 4,409,382, U.S. Pat. No. 4,410,676, U.S. Pat. No. 5,003,039, U.S. Pat. No. 5,003,078, U.S. Pat. No. 5,004,801, U.S. Pat. No. 5,132,396, U.S. Pat. No. 5,159,054, U.S. Pat. No. 5,202,414, U.S. Pat. No. 5,208,318, U.S. Pat. No. 5,237,045, U.S. Pat. No. 5,242,755, U.S. Pat. No. 5,247,060, U.S. Pat. No. 5,292,854, U.S. Pat. No. 5,304,625, U.S. Pat. No. 5,350,828, U.S. Pat. No. 5,352,760, U.S. Pat. No. 5,389,441, U.S. Pat. No. 5,464,926, U.S. Pat. No. 5,925,475, U.S. Pat. No. 5,965,268, U.S. Pat. No. 6,001,926, U.S. Pat. No. 6,297,298, U.S. Pat. No. 6,756,470, U.S. Pat. No. 6,891,014, and U.S. Patent Application Publication Nos. 2004/0181027 and 2004/0181029.

The above references generally teach methods for making and polymerizing phthalonitrile monomers. Such monomers typically have two phthalonitrile groups, one at each end of a connecting spacer chain. The monomers can be cured, whereby the cross-linking occurs between cyano groups. These cross-linked networks typically have high thermal and oxidative stability.

Phthalonitrile resins have potential as matrix materials for advanced composites for radome, airframe, missile, and electronic applications. Phthalonitrile monomers polymerize through the cyano groups with the aid of an appropriate curing agent to yield a crosslinked polymeric network with high thermal and oxidative stabilities. These polymers are obtained by heating the phthalonitrile monomers and a small amount of curing additive in the melt-state for extended periods of time at elevated temperatures. A variety of phthalonitrile monomers containing aromatic ether, thioether, imide, and sulfone linkages between the terminal phthalonitrile units have been synthesized and cured or converted to crosslinked/networked polymers. The cure reaction of these monomers has been investigated by a variety of curing additives such as organic amines, strong organic acids, strong organic acids/amine salts, metallic salts, and metals. When postcured at elevated temperatures to about 400° C., the thermosets show long-term thermal and oxidative stabilities to temperatures approaching 375° C. In addition, the high aromatic content of the thermoset affords a high char yield (80-90%) when pyrolyzed to 1000° C. under inert conditions. The high thermal stability and the ability to form a high char yield upon pyrolysis contribute to the outstanding fire performance of phthalonitrile polymers. For instance, the fire performance of phthalonitrile-carbon and phthalonitrile-glass composites are superior to that of other thermoset-based composites currently in use for aerospace, ship and submarine applications. The phthalonitriles are still the only polymeric material that meets MIL-STD-2031 for usage inside of a submarine.

Low melting oligomeric phthalonitrile monomers and curing additives that do not volatilize at elevated cure reaction temperatures such as bis[4-(4-aminophenoxy)phenyl]sulfone (p-BAPS) have been shown to enhance the overall physical properties and processability of phthalonitrile-based composites. Most high temperature resins are not amenable to processing by cost effective methods such as RTM, resin infusion molding, and oven cure due to high initial viscosities, the evolution of volatiles during the cure, and or solvent-related problems.

### SUMMARY OF THE INVENTION

The invention comprises a compound having the formula in Equation (1). Each R¹ is an independently selected aromatic-containing group. Each R² is independently selected from methyl and phenyl. M is an alkali metal, and n is a positive integer.

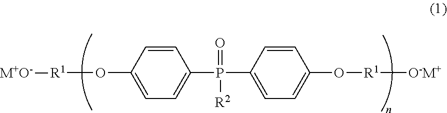

The invention further comprises a compound having the formula in Equation (2). R¹, R², and n are as define above.

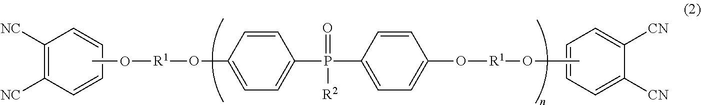

The invention further comprises a thermoset made by curing a mixture comprising a curing agent and the phthalonitrile monomer in Equation (2).

The invention further comprises a method comprising: reacting bis(4-fluorophenyl)phenylphosphine oxide, bis(4-fluorophenyl)methylphosphine oxide, or a mixture thereof with an excess of an aromatic diol in the presence of an alkali metal carbonate to form an oligomer having the formula in Equation (1).

### BRIEF DESCRIPTION OF THE DRAWINGS

A more complete appreciation of the invention will be readily obtained by reference to the following Description of the Example Embodiments and the accompanying drawings.

FIG. 1 shows the synthesis of oligomeric phthalonitrile 1 and thermoset 6.

FIG. 2 shows a DSC thermogram of monomer 1b cured with 3 wt % p-BAPS.

FIG. 3 shows the oxidative aging of polymer 6a (A) and 7a (B) at various temperatures

FIG. 4 shows the oxidative aging of polymers 6b (A) and 7b (B) at various temperatures after being cured with 3% p-BAPS to a maximum temperature of 375° C.

### DETAILED DESCRIPTION OF EXAMPLE EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

The present disclosure is targeted towards developing high temperature and flame resistant composites and addressing composite processability based on cost effective manufacturing techniques such as resin transfer molding (RTM), resin infusion molding, and filament winding. One objective has been concerned with the incorporation of units within the backbone to enhance the flammability resistance and thermo-oxidative properties while retaining low temperature processability. A low melt viscosity resin enables composite processing by resin transfer molding (RTM) and resin infusion methods. Furthermore, a low melt viscosity and a larger processing window are useful for fabrication of thick composite sections where the melt has to impregnate shaped thick fiber preforms.

This disclosure is related to the synthesis and polymerization of low melting oligomeric phthalonitrile monomers containing multiple aromatic ether and phosphine oxide moieties between the terminal phthalonitrile units. The phosphine oxide-containing phthalonitrile monomers upon polymerization to thermosets can have thermo-oxidative and flammability properties for ship, submarine, and aerospace applications and may withstand continuous high temperatures (300-375° C.) in oxidative environments such as air for extended periods. The oligomeric phthalonitrile polymers may have melting points between 50 and 100° C. with the polymerization occurring in excess of 200° C.

The use of low molecular weight precursor resins to obtain thermosetting polymeric materials with high thermo-oxidative properties may be advantageous from a processing standpoint. Precursor resins are useful in composite fabrication by a variety of methods such as infusion, resin transfer molding, and prepreg consolidation. The phthalonitriles may be suitable for numerous aerospace and electronic applications due to their potential thermal and oxidative properties, ease of processability, and low water absorption relative to other high temperature polymers such as polyimides. Furthermore, resins with a large window between the melting point and the cure temperature may be desirable to control the viscosity and the rate of curing. With the phthalonitrile monomers disclosed herein, processability to shaped composite components may be achieved in non-autoclave conditions potentially above 70° C. and by cost effective methods.

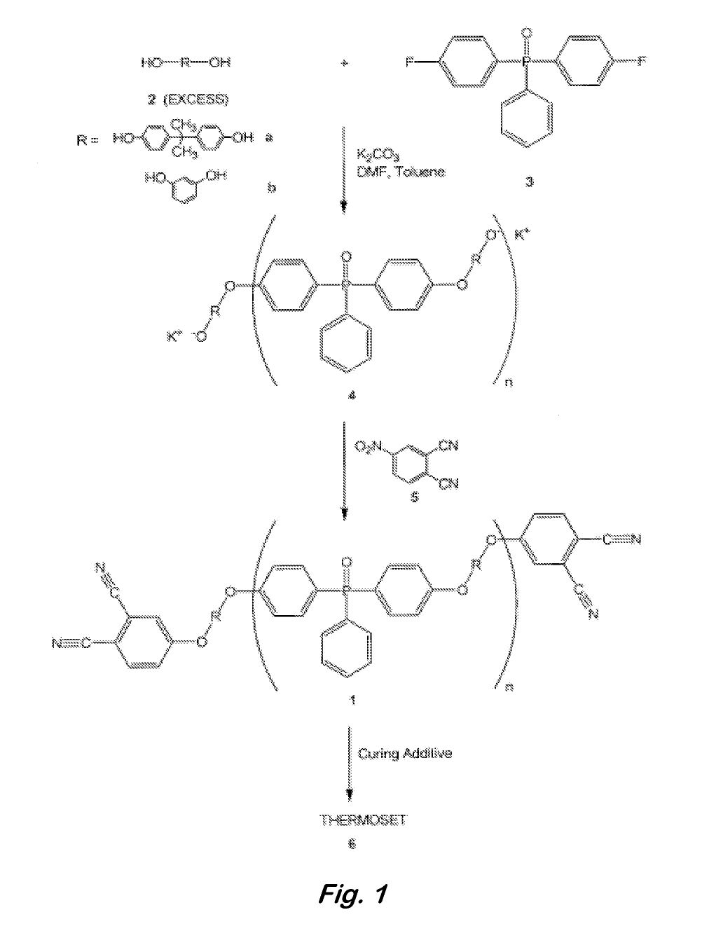

The synthesis of the thermoset may be performed in three steps. First, an aromatic diol is reacted with bis(4-fluorophenyl)phenylphosphine oxide, bis(4-fluorophenyl)methylphosphine oxide, or a mixture thereof to form an oligomer. Second, the oligomer is reacted with a 3- or 4-nitrophthalonitrile to make a phthalonitrile monomer. Third, the phthalonitrile monomer is cured to make a thermoset. These steps are shown in FIG. 1. Any reference to an ingredient can refer to one embodiment of such ingredient or a combination of one or more embodiments. All polymeric and oligomeric structures claimed include all configurations, isomers, and tacticities of the polymers and oligomers within the scope of the claims. The term “oligomer” as used herein does not place any upper or lower limit on the chain length of the oligomer and means that one or more compounds of the general formula are present with the average molecular weight dependent on the ratios of reactants.

The synthesis of a series of oligomeric multiple aromatic ether-linked phthalonitriles that contain an arylene ether phosphine oxide unit in the backbone, was been achieved by a nucleophilic displacement reaction utilizing an activated halogen containing compound, bis(4-fluorophenyl)phenylphosphine oxide 3. Bis(4-fluorophenyl)methylphosphine oxide may also be used instead of or in addition to bis(4-fluorophenyl)phenylphosphine oxide. The potassium diphenolate-terminated intermediate 4 was prepared from the reaction of 2 and 3 in the presence of potassium carbonate as the base in a DMF/toluene solvent mixture. Sodium carbonate may also be used instead of potassium carbonate. Other alkali metal carbonates, including but not limited to cesium carbonate, may also be used. This can allow the azeotropic distillation of the water formed as a by-product in the reaction at temperatures between 135 and 145° C. When no more water is observed being azeotropically distilled and infrared (IR) spectroscopy confirms the desired oligomeric product, the reaction may be considered complete.

An excess of diol is used so that the oligomer is terminated by the diol in metal salt form. Suitable molar ratios of diol to phosphine oxide include, but are not limited to, 2:1, 3:2, 4:3, and 5:4. These ratios produce average values for n of 1, 2, 3, and 4 respectively. Equation (3) shows the product of bisphenol A and bis(4-fluorophenyl)phenylphosphine oxide in a 2:1 ratio. Equation (4) shows the product of resorcinol and bis(4-fluorophenyl)methylphosphine oxide in a 3:2 ratio. The chain lengths shown represent the average length. The product generally contains a mixture of chain lengths.

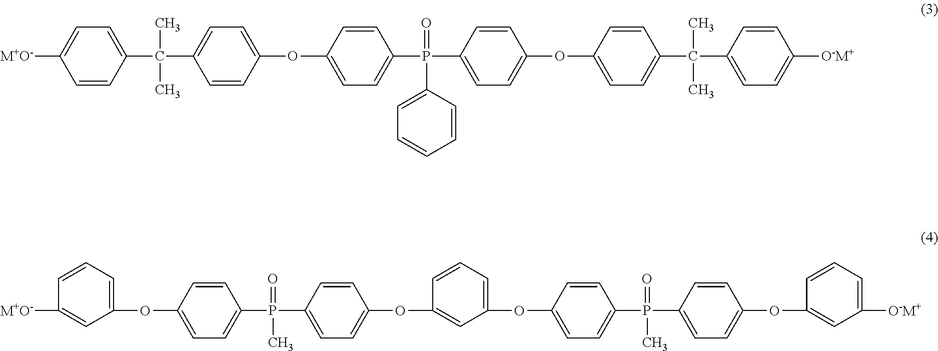

The aromatic diol can be any organic compound having at least two hydroxyl groups and at least one aromatic group. The hydroxyl groups may be directly bound to the aromatic group or to different aromatic groups within the diol. The aromatic diol may contain one or more fused aromatic rings, one or more non-fused aromatic rings with or without intervening functional groups, or combinations thereof, with or without substituents. Suitable diols include, but are not limited to, bisphenol A (4,4′-dihydroxy-2,2-diphenylpropane); bisphenol A6F (1,1,1,3,3,3-hexafluoro-4,4′-dihydroxy-2,2-diphenylpropane); resorcinol (m-dihydroxybenzene); and biphenol (4,4′-dihydroxybiphenyl). The diol may also be a hydroxy-terminated oligomer. More than one diol may be used in a reaction. A “residue” of a diol refers to the moiety of the oligomer formed by removal of the hydrogen atoms from the reacting hydroxyl groups.

In the second step, the oligomer is reacted with 3- or 4-nitrophthalonitrile to make the phthalonitrile monomer. The reaction may result in 90-95% yields. The products may be readily soluble in common organic solvents such as toluene, DMF, acetone, methylene chloride, ether, and chloroform. The structures of the monomers can be confirmed by IR and ¹H-NMR spectroscopy. The oligomeric phthalonitrile resins 1 may generally have melting points between 70 and 100° C. Several oligomeric phthalonitriles 1 have been synthesized by this method and the structures of 1a and 1b are shown in Equations (5) and (6) respectively.

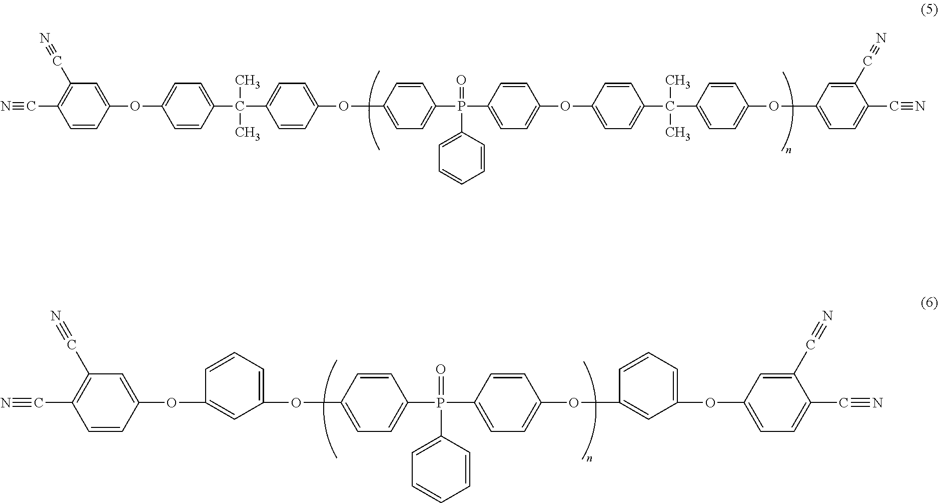

Typically, there is at least a 2:1 molar ratio of nitrophthalonitrile to oligomer to ensure that all terminal groups react with the nitrophthalonitrile. Any remaining unreacted terminal groups can make it more difficult to control the reaction during the curing step. Typically, the oligomer and the nitrophthalonitrile are dissolved in a solvent and heated. As above, the product generally contains a mixture of chain lengths.

In the final step, a mixture comprising the phthalonitrile monomer and a curing agent is cured to form a thermoset. The cyano groups are the cure sites. As these groups react with the curing agent a cross-linked thermoset is formed. The mixture can comprise multiple phthalonitrile monomers having different R¹ and R² groups and different values of n.

The curing agent can be any substance useful in promoting the polymerization of the phthalonitrile monomer. More than one curing agent can be used. Typically, the same amount of curing agent can be used as conventionally used in curing analogous prior art monomers. Typically the curing agent is added to a melt of the phthalonitrile monomer with stirring. The mixture is then cured in one or more curing stages. Typical curing temperatures range from about 80° C. to about 500° C. More typically, the range is from 80° C. to about 375° C. Generally, more complete curing occurs at higher temperatures.

Suitable curing agents include, but are not limited to, aromatic amines, primary amines, secondary amines, diamines, polyamines, amine-substituted phosphazenes, phenols, strong acids, organic acids, strong organic acids, inorganic acids, metals, metallic salts, metallic salt hydrates, metallic compounds, halogen-containing aromatic amines, clays, and chemically modified clays. The use of clays or chemically modified clays may improve the mechanical and flammability properties of the thermoset. Typically, chemical modification of a clay involves replacing sodium ions with ammonium to form quaternary ammonium salts.

Specific curing agents include, but are not limited to, bis[4-(4-aminophenoxy)phenyl]sulfone (p-BAPS), bis[4-(3-aminophenoxy)phenyl]sulfone (m-BAPS), 1,4-bis(3-aminophenoxy)benzene (p-APB), 1,12-diaminododecane, diphenylamine, epoxy amine hardener, 1,6-hexanediamine, 1,3-phenylenediamine, 1,4-phenylenediamine, p-toluenesulfonic acid, cuprous iodide, cuprous bromide, 1,3-bis(3-aminophenoxy)benzene (m-APB), 3,3′-dimethyl-4,4′-diaminodiphenylsulfone, 3,3′-diethoxy-4,4′-diaminodiphenylsulfone, 3,3′-dicarboxy-4,4′-diaminodiphenylsulfone, 3,3′-dihydroxy-4,4′-diaminodiphenylsulfone, 3,3′-disulfo-4,4′-diaminodiphenylsulfone, 3,3′-diaminobenzophenone, 4,4′-diaminobenzophenone, 3,3′-dimethyl-4,4′-diaminobenzophenone, 3,3′-dimethoxy-4,4′-diaminobenzophenone, 3,3′-dicarboxy-4,4′-diaminobenzophenone, 3,3′-dihydroxy-4,4′-diaminobenzophenone, 3,3′-disulfo-4,4′-diaminobenzophenone, 4,4′-diaminodiphenyl ethyl phosphine oxide, 4,4′-diaminodiphenyl phenyl phosphine oxide, bis(3-aminophenoxy-4′-phenyl)phenyl phosphine oxide, methylene dianiline, hexakis(4-aminophenoxy)cyclotriphosphazene, 3,3′-dichloro-4,4′-diaminodiphenylsulfone, 2,2′-bis(trifluoromethyl)-4,4′-diaminobiphenyl, 2,2′-bis(4-aminophenyl)hexafluoropropane, bis[4-(4-aminophenoxy)phenyl]2,2′-hexafluoropropane, 1,1-bis(4-aminophenyl)-1-phenyl-2,2,2-trifluoroethane, 3,3′-dichloro-4,4′-diaminobenzophenone, 3,3′-dibromo-4,4′-diaminobenzophenone, aniline-2-sulfonic acid, 8-aniline-1-naphthalenesulfonic acid, benzene sulfonic acid, butylsulfonic acid, 10-camphorsulfonic acid, 2,5-diaminobenzenesulfonic acid, 6-dimethylamino-4-hydroxy-2-naphthalenesulfonic acid, 5-dimethylamino-1-naphthalenesulfonic acid, 4-hydroxy-3-nitroso-1-naphthalenesulfonic acid tetrahydrate, 8-hydroxyquinoline-5-sulfonic acid, methylsulfonic acid, phenylboric acid, 1-naphthalenesulfonic acid, 2-naphthalenesulfonic acid, 1,5-naphthalenedisulfonic acid, 2,6-naphthalenedisulfonic acid, 2,7-naphthalenedisulfonic acid, picrylsulfonic acid hydrate, 2-pyridineethanesulfonic acid, 4-pyridineethanesulfonic acid, 3-pyridinesulfonic acid, 2-pyridinylhydroxymethanesulfonic acid, sulfanilic acid, 2-sulfobenzoic acid hydrate, 5-sulfosalicylic acid hydrate, 2,4-xylenesulfonic acid, sulfonic acid containing dyes, organic phosphorus-containing acids, phenylphosphinic acid, diphenylphosphinic acid, propylphosphonic acid, 1-aminoethylphosphonic acid, 4-aminophenylphosphonic acid, butylphosphonic acid, t-butylphosphonic acid, 2-carboxyethylphosphonic acid, 2-chloroethylphosphonic acid, dimethylphosphonic acid, ethylphosphonic acid, methylenediphosphonic acid, methylphosphonic acid, phosphonoacetic acid, bis(hydroxymethyl) phosphonic acid, chloromethylphosphonic acid, di-n-butylphosphonic acid, dichloromethylphosphonic acid, diphenyldithiophosphonic acid, 1,2-ethylenediphosphonic acid, n-hystaderylphosphonic acid, hydroxymethylphosphonic acid, n-octadecylphosphonic acid, n-octylphosphonic acid, phenylphosphonic acid, propylenediphosphonic acid; n-tetradecylphosphonic acid, concentrated sulfuric acid, phenylphosphonic acid, copper, iron, zinc, nickel, chromium, molybdenum, vanadium, beryllium, silver, mercury, tin, lead, antimony, calcium, barium, manganese, magnesium, cobalt, palladium, platinum, stannous chloride, cuprous bromide, cuprous cyanide, cuprous ferricyanide, zinc chloride, zinc bromide, zinc iodide, zinc cyanide, zinc ferrocyanide, zinc acetate, zinc sulfide, silver chloride, ferrous chloride ferric chloride, ferrous ferricyanide, ferrous chloroplatinate, ferrous fluoride, ferrous sulfate, cobaltous chloride, cobaltic sulfate, cobaltous cyanide, nickel chloride, nickel cyanide, nickel sulfate, nickel carbonate, stannic chloride, stannous chloride hydrates, stannous chloride dihydrate, aluminum nitrate hydrates, aluminum nitrate nonahydrate, triphenylphosphine oxide complex, montmorillonite, and chemically modified montmorillonite.

The mixture may also comprise 4,4′-bis(3,4-dicyanophenoxy)biphenyl, bis[4-(3,4-dicyanophenoxy)phenyl]dimethylmethane, bis[4-(2,3-dicyanophenoxy)phenyl]dimethylmethane, bis[4-(3,4-dicyanophenoxy)phenyl]-bis(trifluoromethyl)methane, bis[4-(2,3-dicyanophenoxy)phenyl]-bis(trifluoromethyl)methane, 1,3-bis(3,4-dicyanophenoxy)benzene, or 1,4-bis(3,4-dicyanophenoxy)benzene. These compounds are also phthalonitrile monomers. The mixture can also comprise any compound with one or more phthalonitrile groups. Typically, these phthalonitrile compounds have two or more phthalonitrile groups. Such phthalonitrile compounds include, but are not limited to, the phthalonitrile monomers disclosed in the patents cited above. All these compounds can cure with the phthalonitrile monomers of the present disclosure.

The phthalonitrile composition may also comprise an additional component to impart desirable structural or thermal properties. The monomer can be mixed with the additional component before curing. Suitable additional components include, but are not limited to, carbon nanotubes, clays, carbon nanofibers, metal oxides, zinc oxide, and combinations thereof.

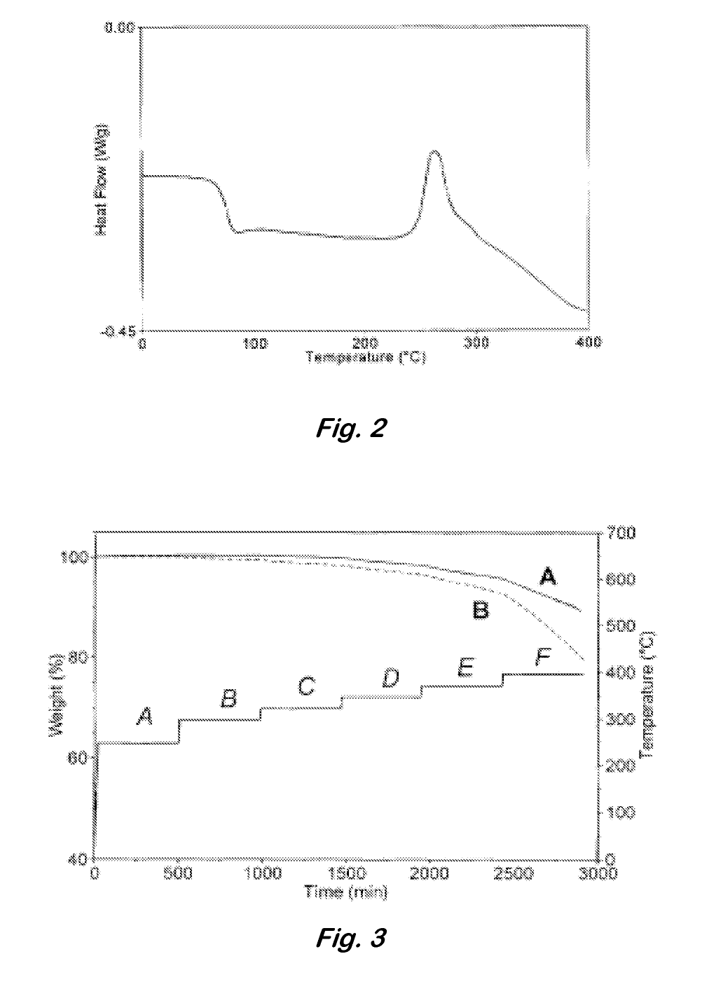

Polymerization studies of 1a and 1b (n=1) were performed by DSC analyses up to 400° C. in the presence of 3 wt % of p-BAPS to afford thermosets, 6a and 6b, respectively. Using monomer 1b as an example, the DSC thermogram (FIG. 2) revealed a glass transition temperature (T_{g}) at approximately 75° C. and an exothermic transition peaking at 260° C. attributed to the softening from the amorphous phase and to the reaction with p-BAPS, respectively. For 1a, these peaks appeared at 90 and 245° C. Therefore, 1a and 1b exhibited low softening temperatures, were completely free flowing around 150° C. (as determined by a visual melting test), and had a long processing window (˜100° C.) before reaction with the curing additive occurred to afford at 6a and 6b, respectively.

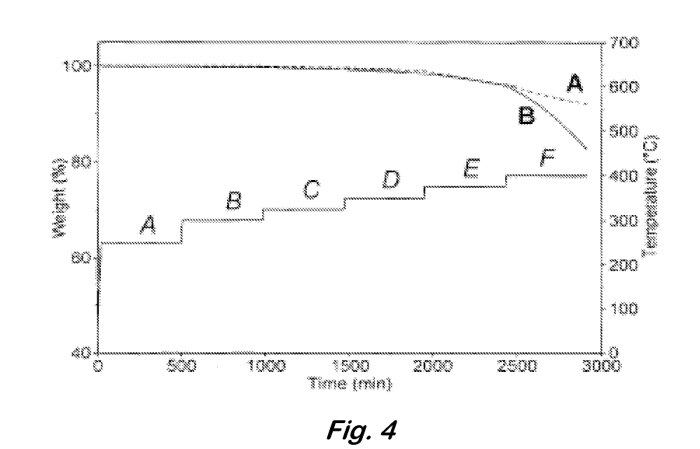

The phthalonitrile monomers may offer a broad processing window, which can be important for the fabrication of complex shaped composite components. The thermosets or cured polymers can show improved thermo-oxidative properties relative to previous phthalonitrile resins including bisphenol A/benzophenone-(7a) and bisphenol A/resorcinol-(7b) based phthalonitriles (Equations (7) and (8)). The viscosity of the polymerization system may be easily controlled for extended periods due to the large processing window, which is defined as the difference between the melting or softening temperature and the polymerization temperature (FIG. 2). Due to the thermal stability of phthalonitrile polymer 6 cured to 400° C., the material has potential for a variety of applications (aerospace, marine, and electronic) including its use in the fabrication of advanced composites by conventional prepreg consolidation, RTM, injection molding, and filament winding and as a coating for electronic devices. Compared to previous phthalonitrile resins including bisphenol A/benzophenone- and bisphenol A/resorcinol-based phthalonitriles, the polymers 6 show much better thermo-oxidative stability (FIGS. 3 and 4). The enhanced thermo-oxidative stability of 6 is especially discernible during the aging studies at elevated temperatures. Thus, the phthalonitrile-based polymers would be expected to exhibit improvements in specific physical properties when used at high temperatures or in a fire environment.

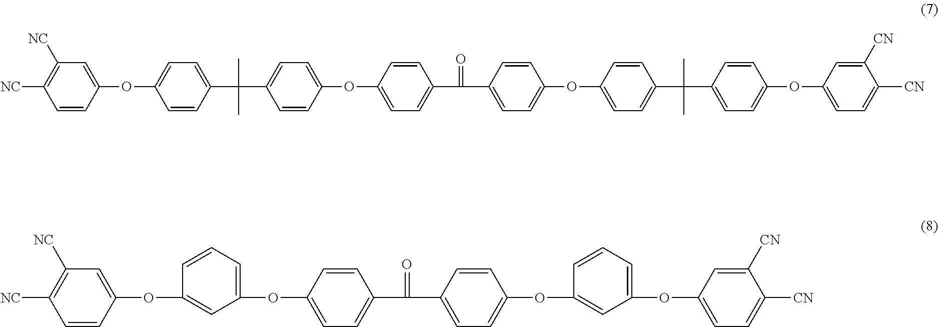

Having described the invention, the following examples are given to illustrate specific applications of the invention. These specific examples are not intended to limit the scope of the invention described in this application.

### Example 1

Synthesis of 2:1 oligomeric phthalonitrile based on bisphenol A and bis(4-fluorophenyl)phenylphosphine oxide—To a 100 mL, three-necked flask fitted with a thermometer, a Dean-Stark trap with condenser, and a nitrogen inlet were added bisphenol A (5.00 g, 21.9 mmol), bis(4-fluorophenyl)phenylphosphine oxide (3.49 g, 11.1 mmol), powdered anhydrous K₂CO₃ (7.55 g, 54.7 mmol), toluene (10 mL), and N,N-dimethylformamide (DMF) (40 mL). The resulting mixture was degassed with argon at ambient temperature and the Dean-Stark trap was filled with toluene. The mixture was refluxed at 135-145° C. under an argon atmosphere for 12 to 18 h or until no more water was observed being collected in the Dean-Stark trap. FTIR spectroscopy was used to confirm and monitor the formation of the desired oligomeric product. Toluene was then removed by distillation and the reaction mixture was cooled to 50° C. At this time, 4-nitrophthalonitrile (3.87 g, 22.4 mmol) was added in one portion and the reaction mixture was heated at 80° C. for 6-8 h. The mixture was allowed to cool to ambient temperature and poured into a 5% aqueous HCl solution resulting in the formation of a solid. The material was broken up and collected using a Büchner funnel. The white solid was dissolved in chloroform (200 mL), and washed with 200 mL of a 5% aqueous KOH solution, with 200 mL of distilled water until neutral, with 200 mL of a 5% aqueous HCl solution, and finally with 200 mL of water until neutral. The solvent was removed in vacuo and the solid was vacuum dried to yield the 2:1 oligomeric phthalonitrile (9.89 g, 91% yield). ¹H-NMR (300 MHz, CDCl₃): δ 7.61-7.52 (m, aromatic-H), 7.43-7.31 (m, aromatic-H), 7.34-7.19 (m, aromatic-H), 7.02-6.92 (m, aromatic-H), 1.75-1.66 (m, CH₃). IR [cm⁻¹]: δ 3058 (C═CH), 2969 (CH₃), 2231 (CN), 1589 (C═C), 1491 (aromatic), 1281 (CH₃), 1248 (C—O), 1173 (C—O), 1117, (P═O), 970 (C—O), 834 (aromatic).

### Example 2

Curing of 2:1 oligomeric phthalonitrile based on bisphenol A and bis(4-fluorophenyl)phenylphosphine oxide with an aromatic amine—Samples containing the 2:1 oligomeric phthalonitrile from example 1 and 2-3 wt % of bis(4-[4-aminophenoxy]phenyl)sulfone (p-BAPS) or 1,3-bis(3-aminophenoxy)benzene (m-APB) were stirred at 200° C. for 2 minutes and cured under nitrogen by heating at 270° C. for 12 h (overnight), 300° C. for 4 h, 350° C. for 4 h, and 375° C. for 8 h to afford a polymer. The polymers exhibited excellent thermal and oxidative stability up to 480° C. before any weight loss was detected. Catastrophic decomposition occurred after 500° C. in air.

### Example 3

Synthesis of 2:1 oligomeric phthalonitrile based on resorcinol and bis(4-fluorophenyl)phenylphosphine oxide—To a 100 mL, three-necked flask fitted with a thermometer, a Dean-Stark trap with condenser, and a nitrogen inlet were added resorcinol (5.00 g, 45.4 mmol), bis(4-fluorophenyl)phenylphosphine oxide (7.14 g, 22.7 mmol), powdered anhydrous K₂CO₃ (12.6 g, 91.0 mmol), toluene (10 mL), and DMF (40 mL). The resulting mixture was degassed with argon at ambient temperature and the Dean-Stark trap was filled with toluene. The mixture was refluxed at 135-145° C. under an argon atmosphere for 12 to 18 h or until no more water was observed being collected in the Dean-Stark trap. FTIR spectroscopy was used to confirm and monitor the formation of the desired oligomeric product. Toluene was then removed by distillation and the reaction mixture was cooled to 50° C. At this time, 4-nitrophthalonitrile (3.87 g, 22.4 mmol) was added in one portion and the reaction mixture was heated at 80° C. for 6-8 h. The mixture was allowed to cool to ambient temperature and poured into a 5% aqueous HCl solution resulting in the formation of a solid. The material was broken up and collected using a Büchner funnel. The white solid was dissolved in chloroform (200 mL), and washed with 200 mL of a 5% aqueous KOH solution, with 200 ml, of distilled water until neutral, with 200 mL of a 5% aqueous HCl solution, and finally with 200 ml, of water until neutral. The solvent was removed in vacuo and the solid was vacuum dried to yield the 2:1 oligomeric phthalonitrile (15.8 g, 93% yield). ¹H-NMR (300 MHz, CDCl₃): δ 7.59-7.39 (m, aromatic-H), 7.30-7.20 (m, aromatic-H), 7.06-6.94 (m, aromatic-H), 6.82-6.72 (m, aromatic-H). IR [cm⁻¹]: δ 3075 (C═CH), 2232 (CN), 1585 (C═C), 1477 (aromatic), 1308 (aromatic), 1244 (C—O), 1172 (C—O), 1122 (P═O), 975 (C—O), 837 (aromatic).

### Example 4

Curing of 2:1 oligomeric phthalonitrile based on resorcinol and bis(4-fluorophenyl)phenylphosphine oxide with an aromatic amine—Samples containing the 2:1 oligomeric phthalonitrile from example 3 and 2-3 wt % of p-BAPS or m-APB were stirred at 200° C. for 2 minutes and cured under nitrogen by heating at 270° C. for 12 h (overnight), 300° C. for 4 h, 350° C. for 4 h, and 375° C. for 8 h to afford a polymer. The polymers exhibited excellent thermal and oxidative stability up to 450° C. before any weight loss was detected. Catastrophic decomposition occurred after 500° C. in air.

### Example 5

Synthesis of 2:1 oligomeric phthalonitrile based on bisphenol A6F and bis(4-fluorophenyl)phenylphosphine oxide—To a 100 mL, three-necked flask fitted with a thermometer, a Dean-Stark trap with condenser, and a nitrogen inlet were added bisphenol A6F (10.80 g, 32.1 mmol), bis(4-fluorophenyl)phenylphosphine oxide (5.00 g, 15.9 mmol), powdered anhydrous K₂CO₃ (8.90 g, 64.5 mmol), toluene (10 mL), and DMF (50 mL). The resulting mixture was degassed with argon at ambient temperature and the Dean-Stark trap was filled with toluene. The mixture was refluxed at 135-145° C. under an argon atmosphere for 12 to 18 h or until no more water was observed being collected in the Dean-Stark trap. FTIR spectroscopy was used to confirm and monitor the formation of the desired oligomeric product. Toluene was then removed by distillation and the reaction mixture was cooled to 50° C. At this time, 4-nitrophthalonitrile (5.59 g, 32.3 mmol) was added in one portion and the reaction mixture was heated at 80° C. for 6-8 h. The mixture was allowed to cool to ambient temperature and poured into a 5% aqueous HCl solution resulting in the formation of a solid. The material was broken up and collected using a Büchner funnel. The white solid was dissolved in chloroform (200 mL), and washed with 200 mL of a 5% aqueous KOH solution, with 200 mL of distilled water until neutral, with 200 mL of a 5% aqueous HCl solution, and finally with 200 mL of water until neutral. The solvent was removed in vacuo and the solid was vacuum dried to yield the 2:1 oligomeric phthalonitrile (15.9 g, 83% yield). IR [cm⁻¹]: δ 3075 (C═CH), 2232 (CN), 1585 (C═C), 1477 (aromatic), 1308 (aromatic), 1244 (C—O), 1172 (C—O), 1122 (P═O), 975 (C—O), 837 (aromatic).

### Example 6

Curing of 2:1 oligomeric phthalonitrile based on bisphenol A6F and bis(4-fluorophenyl)phenylphosphine oxide with an aromatic amine—Samples containing the 2:1 oligomeric phthalonitrile from example 5 and 2-3 wt % of p-BAPS or m-APB were stirred at 200° C. for 2 minutes and cured under nitrogen by heating at 270° C. for 12 h (overnight), 300° C. for 4 h, 350° C. for 4 h, and 375° C. for 8 h to afford a polymer. The polymers exhibited excellent thermal and oxidative stability up to 480° C. before any weight loss was detected. Catastrophic decomposition occurred after 500° C.

### Example 7

Synthesis of 2:1 oligomeric phthalonitrile based on biphenol and bis(4-fluorophenyl)phenylphosphine oxide—To a 250 mL, three-necked flask fitted with a thermometer, a Dean-Stark trap with condenser, and a nitrogen inlet were added 4,4′-biphenol (10.0 g, 53.7 mmol), bis(4-fluorophenyl)phenylphosphine oxide (8.40 g, 26.7 mmol), powdered anhydrous K₂CO₃ (11.1 g, 80.6 mmol), toluene (20 mL), and DMF (100 mL). The resulting mixture was degassed with argon at ambient temperature and the Dean-Stark trap was filled with toluene. The mixture was refluxed at 135-145° C. under an argon atmosphere for 12 to 18 h or until no more water was observed being collected in the Dean-Stark trap. FTIR spectroscopy was used to confirm and monitor the formation of the desired oligomeric product. Toluene was then removed by distillation and the reaction mixture was cooled to 50° C. At this time, 4-nitrophthalonitrile (9.34 g, 54.0 mmol) was added in one portion and the reaction mixture was heated at 80° C. for 6-8 h. The mixture was allowed to cool to ambient temperature and poured into a 5% aqueous HCl solution resulting in the formation of a solid. The material was broken up and collected using a Büchner funnel. The white solid was dissolved in chloroform (200 mL), and washed with 200 mL of a 5% aqueous KOH solution, with 200 mL of distilled water until neutral, with 200 mL of a 5% aqueous HCl solution, and finally with 200 mL of water until neutral. The solvent was removed in vacuo and the solid was vacuum dried to yield the 2:1 oligomeric phthalonitrile (21.6 g, 90% yield). IR [cm⁻¹]: δ 3075 (C═CH), 2232 (CN), 1585 (C═C), 1477 (aromatic), 1310 (aromatic), 1243 (C—O), 1172 (C—O), 1123 (P═O), 977 (C—O), 837 (aromatic).

### Example 8

Curing of 2:1 oligomeric phthalonitrile based on biphenol and bis(4-fluorophenyl)phenylphosphine oxide with an aromatic amine—Samples containing the 2:1 oligomeric phthalonitrile from example 7 and 2-3 wt % of p-BAPS or m-APB were stirred at 200° C. for 2 minutes and cured under nitrogen by heating at 270° C. for 12 h (overnight), 300° C. for 4 h, 350° C. for 4 h, and 375° C. for 8 h to afford a polymer. The polymers exhibited excellent thermal and oxidative stability up to 480° C. before any weight loss was detected. Catastrophic decomposition occurred after 500° C. in air.

### Example 9

Synthesis of 5:4 oligomeric phthalonitrile based on bisphenol A and bis(4-fluorophenyl)phenylphosphine oxide—To a 100 mL, three-necked flask fitted with a thermometer, a Dean-Stark trap with condenser, and a nitrogen inlet were added bisphenol A (5.00 g, 21.9 mmol), bis(4-fluorophenyl)phenylphosphine oxide (5.51 g, 17.5 mmol), powdered anhydrous K₂CO₃ (7.55 g, 54.7 mmol), toluene (10 mL), and DMF (50 mL). The resulting mixture was degassed with argon at ambient temperature and the Dean-Stark trap was filled with toluene. The mixture was refluxed at 135-145° C. under an argon atmosphere for 12 to 18 h or until no more water was observed being collected in the Dean-Stark trap. FTIR spectroscopy was used to confirm and monitor the formation of the desired oligomeric product. Toluene was then removed by distillation and the reaction mixture was cooled to 50° C. At this time, 4-nitrophthalonitrile (1.55 g, 8.96 mmol) was added in one portion and the reaction mixture was heated at 80° C. for 6-8 h. The mixture was allowed to cool to ambient temperature and poured into a 5% aqueous HCl solution resulting in the formation of a solid. The material was broken up and collected using a Büchner funnel. The white solid was dissolved in chloroform (200 mL), and washed with 200 mL of a 5% aqueous KOH solution, with 200 ml, of distilled water until neutral, with 200 mL of a 5% aqueous HCl solution, and finally with 200 ml, of water until neutral. The solvent was removed in vacuo and the solid was vacuum dried to yield the 5:4 oligomeric phthalonitrile (10.2 g, 92% yield). IR [cm⁻¹]: δ 3058 (C═CH), 2969 (CH₃), 2231 (CN), 1589 (C═C), 1491 (aromatic), 1281 (CH₃), 1248 (C—O), 1173 (C—O), 1117, (P═O), 970 (C—O), 834 (aromatic).

### Example 10

Curing of 5:4 oligomeric phthalonitrile based on bisphenol A and bis(4-fluorophenyl)phenylphosphine oxide with an aromatic amine—Samples containing the 2:1 oligomeric phthalonitrile from example 9 and 4 wt % of p-BAPS or m-APB were stirred at 200° C. for 2 minutes and cured under nitrogen by heating at 270° C. for 12 h (overnight), 300° C. for 4 h, 350° C. for 4 h, and 375° C. for 8 h to afford a polymer. The polymers exhibited excellent thermal and oxidative stability up to 450° C. before any weight loss was detected. Catastrophic decomposition occurred after 500° C. in air.

### Example 11

Synthesis of 2:1 oligomeric phthalonitrile based on bisphenol A and bis(4-fluorophenyl)methylphosphine oxide—To a 100 mL, three-necked flask fitted with a thermometer, a Dean-Stark trap with condenser, and a nitrogen inlet were added bisphenol A (5.00 g, 21.9 mmol), bis(4-fluorophenyl)methylphosphine oxide (2.45 g, 10.9 mmol), powdered anhydrous K₂CO₃ (7.55 g, 54.7 mmol), toluene (10 mL), and DMF (40 mL). The resulting mixture was degassed with argon at ambient temperature and the Dean-Stark trap was filled with toluene. The mixture was refluxed at 135-145° C. under an argon atmosphere for 12 to 18 h or until no more water was observed being collected in the Dean-Stark trap. FTIR spectroscopy was used to confirm and monitor the formation of the desired oligomeric product. Toluene was then removed by distillation and the reaction mixture was cooled to 50° C. At this time, 4-nitrophthalonitrile (3.68 g, 21.3 mmol) was added in one portion and the reaction mixture was heated at 80° C. for 6-8 h. The mixture was allowed to cool to ambient temperature and poured into a 5% aqueous HCl solution resulting in the formation of a solid. The material was broken up and collected using a Büchner funnel. The white solid was dissolved in chloroform (200 mL), and washed with 200 mL of a 5% aqueous KOH solution, with 200 ml, of distilled water until neutral, with 200 mL of a 5% aqueous HCl solution, and finally with 200 mL of water until neutral. The solvent was removed in vacuo and the solid was vacuum dried to yield the 2:1 oligomeric phthalonitrile (9.72 g, 90% yield). IR [cm⁻¹]: δ 3058 (C═CH), 2969 (CH₃), 2231 (CN), 1589 (C═C), 1491 (aromatic), 1281 (CH₃), 1248 (C—O), 1173 (C—O), 1117, (P═O), 970 (C—O), 834 (aromatic).

### Example 12

Curing of 2:1 oligomeric phthalonitrile based on bisphenol A and bis(4-fluorophenyl)methylphosphine oxide with an aromatic amine—Samples containing the 2:1 oligomeric phthalonitrile from example 11 and 3 wt % of p-BAPS or m-APB were stirred at 200° C. for 2 minutes and cured under nitrogen by heating at 270° C. for 12 h (overnight), 300° C. for 4 h, 350° C. for 4 h, and 375° C. for 8 h to afford a polymer. The polymers exhibited excellent thermal and oxidative stability up to 470° C. before any weight loss was detected. Catastrophic decomposition occurred after 500° C. in air.

### Example 13

Formulation of carbon nanotubes with a 2:1 oligomeric phthalonitrile based on bisphenol A and bis(4-fluorophenyl)phenylphosphine oxide in a solvent—To a mixture of the 2:1 oligomeric phthalonitrile from example 1 in an appropriate solvent was added various amounts of carbon nanotubes (0.01 to 20 wt %). The mixture was thoroughly mixed. The solvent was removed and the mixture heated and degassed at 200° C. Then 3 wt % of p-BAPS or m-APB was stirred in at 200° C. for 2 minutes and the mixture cured under nitrogen by heating at 270° C. for 12 h (overnight), 300° C. for 4 h, 350° C. for 4 h, and 375° C. for 8 h to afford a polymer. The polymeric compositions exhibited excellent thermal and oxidative stability at 450-500° C. before any weight loss was detected. Catastrophic decomposition occurred after 500° C. in air.

### Example 14

Formulation of clay with a 2:1 oligomeric phthalonitrile based on bisphenol A and bis(4-fluorophenyl)phenylphosphine oxide in a solvent—To a mixture of the 2:1 oligomeric phthalonitrile from example 1 in an appropriate solvent was added various amount of clay (hydrated aluminum silicate) (0.01 to 20 wt %). The resulting mixtures were thoroughly mixed. The solvent was removed and the mixture heated and degassed at 200° C. Then 3-4 wt % of p-BAPS or m-APB was stirred in at 200° C. for 2 minutes and the mixture cured under nitrogen by heating at 270° C. for 12 h (overnight), 300° C. for 4 h, 350° C. for 4 h, and 375° C. for 8 h to afford a polymer. The polymeric mixtures or compositions exhibited excellent thermal and oxidative stability at 450-490° C. before any weight loss was detected. Catastrophic decomposition occurred after 500° C. in air.

### Example 15

Formulation of carbon nanofibers with a 2:1 oligomeric phthalonitrile based on bisphenol A and bis(4-fluorophenyl)phenylphosphine oxide in a solvent—To a mixture of the 2:1 oligomeric phthalonitrile from example 1 in an appropriate solvent was added various amounts of carbon nanofibers (0.01 to 20 wt %). The mixtures were thoroughly mixed by stirring. The solvent was removed and the mixture heated and degassed at 200° C. Then 4 wt % of p-BAPS or m-APB was stirred in at 200° C. for 2 minutes and the mixture cured under nitrogen by heating at 270° C. for 12 h (overnight), 300° C. for 4 h, 350° C. for 4 h, and 375° C. for 8 h to afford a polymer. The polymeric mixtures or compositions exhibited excellent thermal and oxidative stability up to 450-480° C. before any weight loss was detected. Catastrophic decomposition occurred after 500° C. in air.

### Example 16

Formulation of a metal oxide with 2:1 oligomeric phthalonitrile based on bisphenol A and bis(4-fluorophenyl)phenylphosphine oxide in a solvent—To a mixture of the 2:1 oligomeric phthalonitrile from example 1 in an appropriate solvent was added various amount of powdered zinc oxide (0.01 to 20 wt %) with thorough mixing. The solvent was removed and the mixture heated and degassed at 200° C. Then 4-5 wt % of p-BAPS or m-APB was stirred in at 200° C. for 2 minutes and the mixture cured under nitrogen by heating at 270° C. for 12 h (overnight), 300° C. for 4 h, 350° C. for 4 h, and 375° C. for 8 h to afford a polymer. The polymeric mixtures or compositions exhibited excellent thermal and oxidative stability up to 480° C. before a weight loss was detected. Catastrophic decomposition occurred after 500° C. in air.

### Example 17

Formulation of clay with a 2:1 oligomeric phthalonitrile based on bisphenol A and bis(4-fluorophenyl)phenylphosphine oxide by physical mixing—To the 2:1 oligomeric phthalonitrile from example 1 was added various amount of clay (hydrated aluminum silicate) (0.01 to 20 wt %). Thorough mixing was followed by degassed at 200° C. Then 3-5 wt % of p-BAPS or m-APB was stirred in at 200° C. for 2 minutes and the mixture cured under nitrogen by heating at 270° C. for 12 h (overnight), 300° C. for 4 h, 350° C. for 4 h, and 375° C. for 8 h to afford a polymer. The polymeric mixtures or compositions exhibited excellent thermal and oxidative stability up to 480° C. before a weight loss was detected. Catastrophic decomposition occurred after 500° C. in air.

Obviously, many modifications and variations of the present invention are possible in light of the above teachings. It is therefore to be understood that the claimed invention may be practiced otherwise than as specifically described. Any reference to claim elements in the singular, e.g., using the articles “a,” “an,” “the,” or “said” is not construed as limiting the element to the singular.

What is claimed is:

1. A thermoset made by curing a mixture comprising a curing agent and a phthalonitrile monomer have the formula: 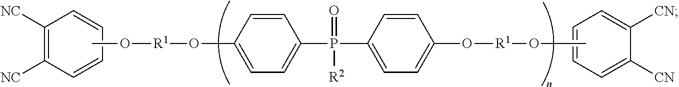
wherein each R¹ is an independently selected aromatic-containing group;
wherein each R² is independently selected from methyl and phenyl; and
wherein n is a positive integer.

2. The thermoset of claim 1, wherein each R¹ is a residue of 4,4′-dihydroxy-2,2-diphenylpropane; 1,1,1,3,3,3-hexafluoro-4,4′-dihydroxy-2,2-diphenylpropane; resorcinol; or biphenol.

3. The thermoset of claim 1, wherein n is 1, 2, 3, or 4.

4. The thermoset of claim 1, wherein the mixture comprises more than one of the phthalonitrile monomers having different values of n.

5. The thermoset of claim 1, wherein the curing agent is a phthalonitrile curing agent, an aromatic amine, bis(4-[4-aminophenoxy]phenyl)sulfone, 1,3-bis(3-aminophenoxy)benzene, or a combination thereof.

6. The thermoset of claim 1, wherein the mixture further comprises carbon nanotubes, a clay, carbon nanofibers, a metal oxide, zinc oxide, or a combination thereof.

7. A method comprising:
reacting bis(4-fluorophenyl)phenylphosphine oxide, bis(4-fluorophenyl)methylphosphine oxide, or a mixture thereof with an excess of an aromatic diol in the presence of an alkali metal carbonate to form an oligomer having the formula: 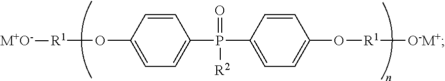
wherein each R¹ is an independently selected aromatic-containing group;
wherein each R² is independently selected from methyl and phenyl;
wherein M is an alkali metal; and
wherein n is a positive integer.

8. The method of claim 7, wherein the aromatic diol is 4,4′-dihydroxy-2,2-diphenylpropane; 1,1,1,3,3,3-hexafluoro-4,4′-dihydroxy-2,2-diphenylpropane; resorcinol; biphenol; or a combination thereof.

9. The method of claim 7, wherein the alkali metal carbonate is potassium carbonate.

10. The method of claim 7, wherein the molar ratio of aromatic diol to the phosphine oxide is about 2:1, 3:2, 4:3, or 5:4.

11. The method of claim 7, wherein the oligomer comprises more than one of the oligomers having different values of n.

12. The method of claim 7, further comprising:
reacting the oligomer with a nitrophthalonitrile to form a phthalonitrile monomer having the formula:

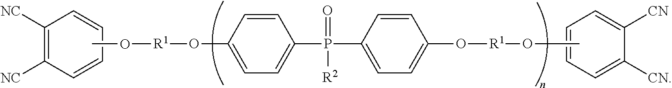

13. The method of claim 12, further comprising:
curing a mixture comprising a curing agent and the phthalonitrile monomer.

14. The method of claim 13, wherein the curing agent is a phthalonitrile curing agent, an aromatic amine, bis(4-[4-aminophenoxy]phenyl)sulfone, 1,3-bis(3-aminophenoxy)benzene, or a combination thereof.

15. The method of claim 13, wherein the mixture further comprises carbon nanotubes, a clay, carbon nanofibers, a metal oxide, zinc oxide, or a combination thereof.
